(19) United States
(12) Patent Application Publication
(10) Pub. No.: US 2005/0238121 A1
(43) Pub. Date: Oct. 27, 2005

(54) System and method for determining a modulation angle of an information bit in a complex modulated signal

(75) Inventors: Chang Qing Xu, Singapore (SG); Masayuki Tomisawa, Singapore (SG)

Correspondence Address: QUARLES & BRADY LLP, 411 E. WISCONSIN AVENUE, SUITE 2040, MILWAUKEE, WI, 53202-4497, US

(73) Assignee: Oki Techno Centre (Singapore) Pte Ltd.

(21) Appl. No.: 11/089,512

(22) Filed: Mar. 24, 2005

(30) Foreign Application Priority Data
Apr. 21, 2004 (SG) 200402277-8

(51) Int. Cl. H04L 27/14

(52) U.S. Cl. 375/322

(57) ABSTRACT

A system and method for determining a modulation angle of an information bit in a modulated complex signal comprise, in a first stage, determining the inphase component I and the quadrature component Q of the information bit in the modulated complex signal. A division stage determines an absolute ratio of the quadrature component Q to the inphase component I and a second stage determines from the polarity of the inphase and quadrature components the quadrant in which the modulation angle lies. A third stage determines the arctangent of the absolute ratio x of the quadrature component Q to the inphase component I of the transmitted information bit in the modulated signal. A fourth stage determines the modulation angle from the polarity of the inphase and quadrature components and the arctangent of the absolute ratio of the quadrature component Q to the inphase component I of the transmitted information bit in the modulated signal.

### FIELD OF THE INVENTION

The present invention relates to a system and method for determining a modulation angle of an information bit in a modulated complex signal, for example a signal which has been modulated according to a phase shift keying (PSK) or a differential phase shift keying (DPSK) modulation scheme.

### BACKGROUND OF THE INVENTION

Phase shift keying (PSK) and differential phase shift keying (DPSK) modulation schemes are widely used in wireless communications systems. QPSK, which is a variation of PSK, has been included in third generation mobile systems, as described in Personal Handy Phone System, RCR STD-28, Ver. 1, Rev. 1, 1995. Furthermore, QPSK, as well as BPSK, DBPSK, and DQPSK is employed in wireless local access network (WLAN) systems, as described in Wireless LAN Medium Access Control (MAC) and physical layer (PHY) specifications, IEEE Standard 802.11, 1999. Other variations such as pi/4-DQPSK and 8DPSK are specified for use in Bluetooth systems, as described in Bluetooth Medium Rate Specifications, V 0.7, Bluetooth SIG, April 2003.

In such wireless communications systems, the information to be transmitted is converted into a number of modulation angles which are then transmitted as complex symbols. To recover the information data, the received complex symbols must be converted back to modulation angles. The modulation angles are then converted to digital format to provide the digital information bits representative of the transmitted information. Thus, one major task in PSK/DPSK demodulation is to determine the modulation angles of the received modulated complex symbols. This is achieved by determining the inverse tangent of the received modulated complex symbol.

One conventional method for obtaining the inverse tangent of a complex symbol is to use a look-up table. However, this method requires a large memory as a large number of entries in the look-up table are needed to provide the required resolution of the modulation angles.

Another conventional method for determining the inverse tangent of a complex symbol is to use a co-ordinate rotation digital computer (CORDIC) algorithm such as that described in Hu, X., Harber, R. G. and Bass, S. C., “Expanding the range of convergence of the CORDIC algorithm”, IEEE Transactions on Computers, Vol. 40, No. 1, January, 1991, pp. 13-21. However, this iterative algorithm is quite complex.

In view of the foregoing disadvantages of conventional methods, a need exists for a method and apparatus for determining modulation angles in systems in which PSK/DPSK demodulation is applied which is not complex and does not require a large memory.

### SUMMARY OF THE INVENTION

In general terms, there is provided a method and system for determining a modulation angle of an information bit in a modulated complex signal by determining the inverse tangent of the absolute value of the quadrature component Q to the inphase component I of the modulated complex signal.

According to a first aspect of the invention there is provided a system for determining a modulation angle of an information bit in a modulated complex signal, the modulation angle lying in one of four quadrants corresponding to angles from zero radians to 2pi radians, the information bit having an associated inphase component I and an associated quadrature component Q, the inphase and quadrature components each having an associated polarity, the system comprising: a first stage for determining the inphase component I and the quadrature component Q of the information bit in the modulated complex signal; a division stage for determining an absolute ratio of the quadrature component Q to the inphase component I; and a second stage for determining from the polarity of the inphase and quadrature components the quadrant in which the modulation angle lies; a third stage for determining the arctangent of the absolute ratio x of the quadrature component Q to the inphase component I of the transmitted information bit in the modulated signal; and a fourth stage for determining the modulation angle from the polarity of the inphase and quadrature components and the arctangent of the absolute ratio of the quadrature component Q to the inphase component I of the transmitted information bit in the modulated signal.

The system of may further comprise a comparator stage for comparing the absolute ratio of the quadrature component Q to the inphase component I with a number of predetermined ranges of values to determine which process to apply to obtain the value of the arctangent.

The third stage may be arranged to determine the arctangent of the absolute ratio x of the quadrature component Q to the inphase component I according to the equation: atan(x)=x−x³/3+x⁵/5−x⁷17+x⁹/9−x¹¹/11+x¹³/13, if x lies in the range 0 to 7/16.

The third stage may be arranged to determine the arctangent of the absolute ratio x of the quadrature component Q to the inphase component I according to the equation: atan(x)=x−x³/3+x⁵/5, if x lies in the range 0 to 7/16.

The third stage may be arranged to determine the arctangent of the absolute ratio x of the quadrature component Q to the inphase component I according to the equation: atan(x)=x−x³/3+x⁵/5−x⁷/7, if x lies in the range 0 to 7/16.

The third stage may be arranged to determine the arctangent of the absolute ratio x of the quadrature component Q to the inphase component I according to the equation: atan(x)=x−x³/3+x⁵/5−x⁷/7+x⁹/9, if x lies in the range 0 to 7/16.

The third stage may be arranged to determine the arctangent of the absolute ratio x of the quadrature component Q to the inphase component I according to the equation: atan(x)=x−x³/3+x⁵/5−x⁷/7+x⁹/9−x¹¹11 . . . , if x lies in the range 0 to 7/16. It will be understood that the expression increases in accuracy, the more terms are included, with the expression being exact if the expansion is continued to an infinite number of terms. An appropriate number of terms may be included in the expression for atan(x) depending on the accuracy required.

The third stage may be arranged to determine the arctangent of the absolute ratio x of the quadrature component Q to the inphase component I according to the equation: atan(x)=atan(0.5)+atan(y), where atan(y)=((x−0.5)/(1+0.5 x))−((x−0.5)/(1+0.5 x))³/3+((x−0.5)/(1+0.5 x))⁵/5−((x−0.5)/(1+0.5 x))⁷/7+((x−0.5)/(1+0.5 x))⁹/9−((x−0.5)/(1+0.5 x))¹/11+((x−0.5)/(1+0.5 x))¹³/13 . . . , if x lies in the range 7/16 to 11/16.

The third stage may be arranged to determine the arctangent of the absolute ratio x of the quadrature component Q to the inphase component I according to the equation: atan(x)=atan(1)+atan(z), where atan(z)=((x−1)/(1+x))−((x−1)/(1+x))³/3+((x−1)/(1+x))⁵/5−((x−1)/(1+x))⁷/7+((x−1)/(1+x))⁹/9−((x−1)/(1+x))¹¹/11+((x−1)/(1+x))¹³/13 . . . , if x lies in the range 11/16 to 19/16.

The third stage may be arranged to determine the arctangent of the absolute ratio x of the quadrature component Q to the inphase component I according to the equation: atan(x)=atan(1.5)+atan(p), where atan(p)=(x−1.5)/(1+1.5 x)−((x−1.5)/(1+1.5 x))³/3+((x−1.5)/(1+1.5 x))⁵/5−((x−1.5)/(1+1.5 x))⁷/7+((x−1.5)/(1+1.5 x))⁹/9−((x−1.5)/(1+1.5 x))¹¹/11+((x−1.5)/(1+1.5 x))¹³/13 . . . , if x lies in the range 19/16 to 39/16.

The third stage may be arranged to determine the arctangent of the absolute ratio x of the quadrature component Q to the inphase component I according to the equation: atan(x)=atan(INF)+atan(−1/x), where atan(−1/x)=(−1/x)−((−1/x))³/3+((−1×))⁵/5−((−1 x))⁷/7+((−1/x))⁹/9−((−1/x))¹¹/11+((−1−x))¹³/13 . . . , if x lies in the range 39/16 to infinity, where atan(INF)=1.5708.

The fourth stage may be arranged to determine the modulation angle according to the equation: modulation angle=atan(x), if the polarity of the inphase and quadrature components is positive.

The fourth stage may be arranged to determine the modulation angle according to the equation: modulation angle=pi-atan(x), if the polarity of the inphase component I is negative and the polarity of the quadrature component Q is positive.

The fourth stage may be arranged to determine the modulation angle according to the equation: modulation angle=pi+atan(x), if the polarity of the inphase component I and the quadrature component Q is negative.

The fourth stage may be arranged to determine the modulation angle according to the equation: modulation angle=2*pi-atan(x), if the polarity of the inphase component I is positive and the polarity of the quadrature component Q is negative.

The third stage may be arranged to determine the arctangent of the absolute ratio x of the quadrature component Q to the inphase component I according to the equation: atan(x)=x, if x lies in the range 0 to 7/16.

Any one or more of the first stage, the division stage, the second stage, the third stage and the fourth stage may be implemented in software.

Any one or more of the first stage, the division stage, the second stage, the third stage and the fourth stage may be implemented in hardware.

According to a second aspect of the present invention there is provided an apparatus for determining modulation angles of a complex signal which has been modulated according to a phase shift keying. (PSK) or a differential phase shift keying (DPSK) modulation scheme comprising the system defined above.

According to a third aspect of the present invention there is provided a method for determining a modulation angle of an information bit in a modulated complex signal, the modulation angle lying in one of four quadrants corresponding to angles from zero radians to 2pi radians, the information bit having an associated inphase component I and an associated quadrature component Q, the inphase and quadrature components each having an associated polarity, the method comprising the steps of: determining the inphase component I and the quadrature component Q of the information bit in the modulated complex signal; determining an absolute ratio of the quadrature component Q to the inphase component I; and determining from the polarity of the inphase and quadrature components the quadrant in which the modulation angle lies; determining the arctangent of the absolute ratio x of the quadrature component Q to the inphase component I of the transmitted information bit in the modulated signal; and determining the modulation angle from the polarity of the inphase and quadrature components and the arctangent of the absolute ratio of the quadrature component Q to the inphase component I of the transmitted information bit in the modulated signal.

The method may further comprise comparing the absolute ratio of the quadrature component Q to the inphase component I with a number of predetermined ranges of values to determine which process to apply to obtain the value of the arctangent.

The step of determining the arctangent of the absolute ratio x of the quadrature component Q to the inphase component I may comprise determining the arctangent according to the equation: atan(x)=x−x³/3+x⁵/5−x⁷/7+x⁹/9−x¹¹/11+x¹³/13, if x lies in the range 0 to 7/16.

The step of determining the arctangent of the absolute ratio x of the quadrature component Q to the inphase component I may comprise determining the arctangent according to the equation: atan(x)=x−x³/3+x⁵/5, if x lies in the range 0 to 7/16.

The step of determining the arctangent of the absolute ratio x of the quadrature component Q to the inphase component I may comprise determining the arctangent according to the equation: atan(x)=x−x³/3+x⁵/5−x⁷/7, if x lies in the range 0 to 7/16.

The step of determining the arctangent of the absolute ratio x of the quadrature component Q to the inphase component I may comprise determining the arctangent according to the equation: atan(x)=x−x³/3+x⁵/5−x⁷/7+x⁹/9, if x lies in the range 0 to 7/16.

The step of determining the arctangent of the absolute ratio x of the quadrature component Q to the inphase component I may comprise determining the arctangent according to the equation: atan(x)=x−x³/3+x⁵/5−x⁷/7+x⁹/9−x¹¹/11, if x lies in the range 0 to 7/16.

The step of determining the arctangent of the absolute ratio x of the quadrature component Q to the inphase component I may comprise determining the arctangent according to the equation: atan(x)=atan(0.5)+atan(y), where atan(y)=((x−0.5)/(1+0.5 x))−((x−0.5)/(1+0.5 x))³/3+((x−0.5)/(1+0.5 x))⁵/5−((x−0.5)/(1+0.5 x))⁷/7+((x−0.5)/(1+0.5 x))⁹/9−((x−0.5)/(1+0.5 x))¹¹/11+((x−0.5)/(1+0.5 x))¹³/13 . . . , if x lies in the range 7/16 to 11/16.

The step of determining the arctangent of the absolute ratio x of the quadrature component Q to the inphase component I may comprise determining the arctangent according to the equation: atan(x)=atan(1)+atan(z), where atan(z)=((x−1)/(1+x))−((x−1)/(1+x))³/3+((x−1)/(1+x))⁵/5−((x−1)/(1+x))⁷/7+((x−1)/(1+x))⁹/9−((x−1)/(1+x))¹¹/11+((x−1)/(1+x))¹³/13 . . . , if x lies in the range 11/16 to 19/16.

The step of determining the arctangent of the absolute ratio x of the quadrature component Q to the inphase component I may comprise determining the arctangent according to the equation: atan(x)=atan(1.5)+atan(p), where atan(p)=(x−1.5)/(1+1.5 x)−((x−1.5)/(1+1.5 x))³/3+((x−1.5)/(1+1.5 x))⁵/5−((x−1.5)/(1+1.5 x))⁷/7+((x−1.5)/(1+1.5 x))⁹/9−((x−1.5)/(1+1.5 x))¹¹/11+((x−1.5)/(1+1.5 x))¹³/13 . . . , if x lies in the range 19/16 to 39/16.

The step of determining the arctangent of the absolute ratio x of the quadrature component Q to the inphase component I may comprise determining the arctangent according to the equation: atan(x)=atan(INF)+atan(−1/x), where atan(−1/x)=(−1/x)−((−1×))³/3+((−11×))⁵/5−((−1/x))⁷/7+((−1 x))⁹/9−((−1/x))¹¹/11+((−1/x))¹³/13 . . . , if x lies in the range 39/16 to infinity, where atan(INF)=1.5708.

The step of determining the modulation angle may comprise determining the modulation angle according to the equation: modulation angle=atan(x), if the polarity of the inphase and quadrature components is positive.

The step of determining the modulation angle may comprise determining the modulation angle according to the equation: modulation angle=pi-atan(x), if the polarity of the inphase component I is negative and the polarity of the quadrature component Q is positive.

The step of determining the modulation angle may comprise determining the modulation angle according to the equation: modulation angle=pi+atan(x), if the polarity of the inphase component I and the quadrature component Q is negative.

modulation angle according to the equation: modulation angle=2*pi-atan(x), if the polarity of the inphase component I is positive and the polarity of the quadrature component Q is negative.

The step of determining the arctangent of the absolute ratio x of the quadrature component Q to the inphase component I may comprise determining the arctangent according to the equation: atan(x)=x, if x lies in the range 0 to 7/16.

Any one or more of the method steps may be implemented in software. Any one or more of the method steps may be implemented in hardware.

According to a fourth aspect of the present invention there is provided a method for determining modulation angles of a complex signal comprising repeating applying the method defined above for each information bit in the modulated complex signal to be demodulated.

According to a fifth aspect of the present invention there is provided a method for determining modulation angles of a complex signal which has been modulated according to a phase shift keying (PSK) or a differential phase shift keying (DPSK) modulation scheme comprising the method defined above.

A simpler demodulation apparatus for PSK/DPSK modulation schemes may be derived using the embodiments of the invention. The embodiments of the invention thereby assist in reducing the complexity of demodulation schemes such as PSK/DPSK.

### BRIEF DESCRIPTION OF THE DRAWING

The present invention will now be described by way of example and with reference to the accompanying drawing which is a flow diagram showing the process steps in determining the modulation angle in a system according to an embodiment of the present invention.

### DESCRIPTION OF PREFERRED EMBODIMENTS

The first preferred embodiment is described with reference to an apparatus and method for determining modulation angles of a complex signal which has been modulated according to, for example, a phase shift keying (PSK) or a differential phase shift keying (DPSK) modulation scheme. An incoming modulated complex signal is received on a carrier and is converted to a baseband signal in a conventional front-end apparatus (not shown).

In the following description, it is assumed that the received modulated complex signal has the format (1+jQ) where I and Q are the inphase and quadrature values respectively.

To demodulate the modulated complex signals to recover the transmitted information, it is first necessary to determine the modulation angles for each information bit in the signal, the modulation angle being the arctangent of the ratio of the quadrature component Q to the inphase component I of the transmitted information bit in the modulated signal. The source information may then be demodulated by making a decision based on these modulation angles and corresponding mapping rules.

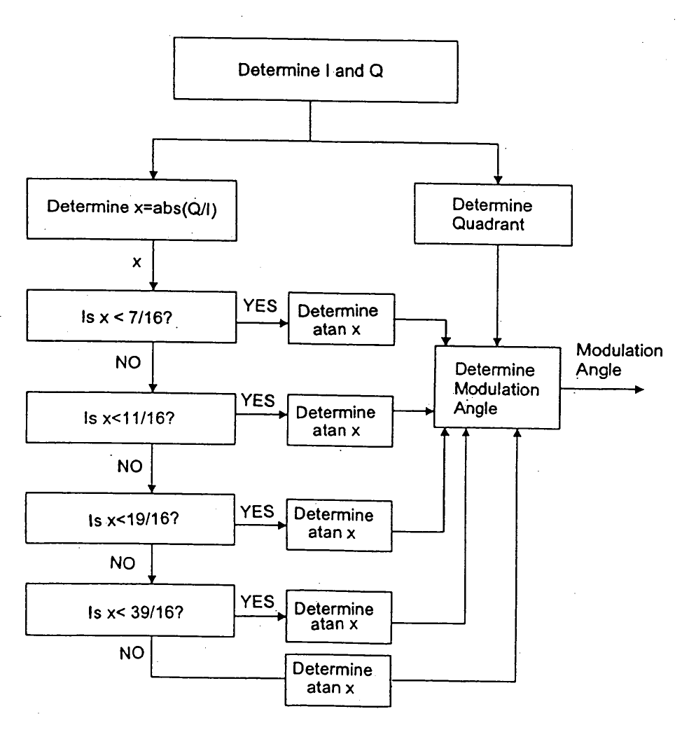

As shown in FIG. 1, in a first stage, the inphase I and quadrature Q components of the incoming modulated complex signal are determined for each information bit using, for example, conventional means. The inphase I and quadrature Q components are then passed to a stage which determines, from the sign, that is the polarity (positive or negative) of the inphase I and quadrature Q components, the quadrant of the modulation angle. Simultaneously or otherwise, the ratio of the quadrature component Q to the inphase component I is determined in a further stage. The absolute value x of this ratio (x=abs(Q/I)) is compared with predetermined ranges of values to determine which process to apply to obtain the value of the arctangent of x. Once it has been determined which process is to be applied, the arctangent of x is determined. Then, using the determined quadrant information and the arctangent of x information, the modulation angle is determined. The modulation angle may then be used to recover the original signal using a conventional demodulation scheme. The aforementioned process is repeated for each information bit in the signal to be demodulated.

If the range of the inverse tangent of x, that is atan(x), is set to be in the range 0 to 2*pi, the arctangent of x may be calculated by one of the following processes:

For x lies in the range 0 to 7/16, atan(x)=x−x³/3+x⁵/5−x7/7+x⁹/9−x¹¹/11+x¹³/13 This is denoted as Equation [1].

For x lies in the range 7/16 to 11/16, atan(x)=atan(0.5)+atan((x−0.5)/(1+0.5 x)). In this case, the absolute value of (x−0.5)/(1+0.5 x) will be in the range 0 to 7/16 and therefore atan((x−0.5)/(1+0.5 x)) may be calculated using equation [1] where ((x−0.5)/(1+0.5 x)) is substituted for x in the right-hand side of equation [1]. Thus, if x lies in the range 7/16 to 11/16, atan(x)=atan(0.5)+((x−0.5)/(1+0.5 x))−((x−0.5)/(1+0.5 x))³/3+((x−0.5)/(1+0.5 x))⁵/5−((x−0.5)/(1+0.5 x))⁷/7+((x−0.5)/(1+0.5 x))⁹/9 . . .

For x lies in the range 11/16 to 19/16, atan(x)=atan(1)+atan((x−1)/(1+x)). In this case, the absolute value of (x−1)/(1+x) will be in the range 0 to 7/16 and therefore atan((x−1)/(1+x)) may be calculated using equation [1] where ((x−1)/(1+x)) is substituted for x in the right-hand side of equation [1]. Thus, if x lies in the range 11/16 to 19/16, atan(x)=atan(1)+((x−1)/(1+x))−((x−1)/(1+x))³/3+((x−1)/(1+x))⁵/5−((x−1)/(1+x))⁷/7+((x−1)/(1+x))⁹/9−((x−1)/(1+X))11/11+((x−1)/(1+X))¹³/13.

For x lies in the range 19/16 to 39/16, atan(x)=atan(1.5)+atan((x−1.5)/(1+1.5 x)). In this case, the absolute value of (x−1.5)/(1+1.5 x) will be in the range 0 to 7/16 and therefore atan((x−1.5)/(1+1.5 x)) may be calculated using equation [1] where ((x−1.5)/(1+1.5 x)) is substituted for x in the right-hand side of equation [1]. Thus, if x lies in the range 19/16 to 39/16, atan(x)=atan(1.5)+((x−1.5)/(1+1.5 x))−((x−1.5)/(1+1.5 x))³/3+((x−1.5)/(1+1.5 x))⁵/5−((x−1.5)/(1+1.5 x))⁷/7+((x−1.5)/(1+1.5 x))⁹/9−((x−1.5)/(1+1.5 x))¹¹11+((x−1.5)/(1+1.5 x))¹³/13 . . .

For x lies in the range 39/16 to infinity, atan(x)=atan(INF)+atan(−1/x). In this case, the absolute value of (−1/x) will be in the range 0 to 7/16 and therefore atan(−1/x) may be calculated using equation [1] where (−1/x) is substituted for x in the right-hand side of equation [1]. Thus, if x lies in the range 39/16 to infinity, atan(x)=atan(INF)+(−1/x)−(−1/x)³/3+(−1/x)⁵/5−(−1/X)⁷17+(−11×)⁹/9−(−1/X)¹¹/11+(−1/X)13/13 . . .

It should be noted that atan(−x)=-atan(x) and this is applied where necessary; atan(0.5)=0.4636; atan(1)=0.7854; atan(1.5)=0.9828; and atan(INF)=1.5708.

The number of items in Equation [1] depends on the bit width requirement of the system. For example, the first 3 items are enough for a bit width of 8. This applies to any of the subsequent equations in which equation [1] is applied.

The modulation angle may be derived from atan(x) and the quadrant information of the complex symbol in the following manner:
For a complex symbol in the first-quadrant, that is, when I and Q are both positive (+,+), the modulation angle=atan(x);
For a complex symbol in the second-quadrant, that is, when I is negative and Q is positive (−,+), the modulation angle=pi-atan(x);
For a complex symbol in the third-quadrant, that is, when I and Q are both negative (−,−), the modulation angle=pi+atan(x);
For a complex symbol in the fourth-quadrant, that is, when I is positive and Q is negative (+,−), the modulation angle=2*pi-atan(x).

As mentioned above, the modulation angle may then be used to recover the original signal using a conventional demodulation scheme. The aforementioned process is repeated for each information bit in the signal to be demodulated.

In an alternative embodiment, to reduce further the complexity of the system and method, an approximation of Equation (1) may be used to obtain the arctangent of x. That is, for x lies in the range 0 to 7/16, atan(x)=x. The other processes mentioned above for obtaining atan(x) where x is greater than 7/16 remain unchanged.

With the method and apparatus embodying the invention, the computational load necessary to determine modulation angles of complex baseband signals may be reduced. Therefore, a simpler demodulation apparatus for PSK/DPSK modulation schemes may be derived. The embodiments of the invention thereby assist in reducing the complexity of demodulation schemes such as PSK/DPSK.

Depending on the application in which the apparatus and methods embodying the invention are to be used, all or part of the apparatus/process steps described above may be constructed or integrated in hardware, for example, an ASIC. Alternatively, part or all of the apparatus/process steps described above may be implemented in software.

Various modifications to the embodiments of the present invention described above may be made. For example, other method steps may be added or substituted for those above. Thus, although the invention has been described above using particular embodiments, many variations are possible within the scope of the claims, as will be clear to the skilled reader, without departing from the spirit and scope of the invention.

1. A system for determining a modulation angle of an information bit in a modulated complex signal, the modulation angle lying in one of four quadrants corresponding to angles from zero radians to 2pi radians, the information bit having an associated inphase component I and an associated quadrature component Q, the inphase and quadrature components each having an associated polarity, the system comprising:
a first stage for determining the inphase component I and the quadrature component Q of the information bit in the modulated complex signal;
a division stage for determining an absolute ratio of the quadrature component Q to the inphase component I; and
a second stage for determining from the polarity of the inphase and quadrature components the quadrant in which the modulation angle lies;
a third stage for determining the arctangent of the absolute ratio x of the quadrature component Q to the inphase component I of the transmitted information bit in the modulated signal; and
a fourth stage for determining the modulation angle from the polarity of the inphase and quadrature components and the arctangent of the absolute ratio of the quadrature component Q to the inphase component I of the transmitted information bit in the modulated signal.

2. The system of claim 1, further comprising a comparator stage for comparing the absolute ratio of the quadrature component Q to the inphase component I with a number of predetermined ranges of values to determine which process to apply to obtain the value of the arctangent.

3. The system of claim 1, wherein the third stage is arranged to determine the arctangent of the absolute ratio x of the quadrature component Q to the inphase component I according to the equation:
atan(x)=x−x³/3+x⁵/5−x⁷/7+x⁹19−x¹¹/11+x¹³/13
if x lies in the range 0 to 7/16.

4. The system of claim 1, wherein the third stage is arranged to determine the arctangent of the absolute ratio x of the quadrature component Q to the inphase component I according to the equation:
atan(x)=atan(0.5)+atan(y)
where atan(y)=((x−0.5)/(1+0.5 x))−((x−0.5)/(1+0.5 x))³/3+((x−0.5)/(1+0.5 x))⁵/5−((x−0.5)/(1+0.5 x))⁷/7+((x−0.5)/(1+0.5 x))⁹/9−((x−0.5)/(1+0.5 x))¹¹/11+((x−0.5)/(1+0.5 x))¹³ . . .
if x lies in the range 7/16 to 11/16.

5. The system of claim 1, wherein the third stage is arranged to determine the arctangent of the absolute ratio x of the quadrature component Q to the inphase component I according to the equation:
atan(x)=atan(1)+atan(z)
where atan(z)=((x−1)/(1+x))−((x−1)/(1+x))³/3+((x−1)/(1+x))⁵/5−((x−1)/(1+x))⁷/7+((x−1)/(1+x))⁹/9−((x−1)/(1+x))¹³/13+((x−1)/(1+x))¹³/13 . . .
if x lies in the range 11/16 to 19/16.

6. The system of claim 1, wherein the third stage is arranged to determine the arctangent of the absolute ratio x of the quadrature component Q to the inphase component I according to the equation:
atan(x)=atan(1.5)+atan(p)
where atan(p)=(x−1.5)/(1+1.5 x)−((x−1.5)/(1+1.5 x))³/3+((x−1.5)/(1+1.5 x))⁵/5−((x−1.5)/(1+1.5 x))⁷/7+((x−1.5)/(1+1.5 x))⁹/9−((x−1.5)/(1+1.5 x))¹¹/11+((x−1.5)/(1+1.5 x))¹³/13 . . .
if x lies in the range 19/16 to 39/16.

7. The system of claim 1, wherein the third stage is arranged to determine the arctangent of the absolute ratio x of the quadrature component Q to the inphase component I according to the equation:
atan(x)=atan(INF)+atan(−1/x)
where atan(−1/x)=(−1/x)−((−11×))³/3+((−1×))⁵15−((−1/x))⁷/7+((−1 x))⁹/9−((−1/X))¹¹/11+((−1/x)31 . . .
if x lies in the range 39/16 to infinity, where atan(INF)=1.5708.

8. The system of claim 1, wherein the third stage is arranged to determine the arctangent of the absolute ratio x of the quadrature component Q to the inphase component I according to the equation:
atan(x)=x
if x lies in the range 0 to 7/16.

9. An apparatus for determining modulation angles of a complex signal which has been modulated according to a phase shift keying (PSK) or a differential phase shift keying (DPSK) modulation scheme comprising the system of any one of the preceding claims.

10. A method for determining a modulation angle of an information bit in a modulated complex signal, the modulation angle lying in one of four quadrants corresponding to angles from zero radians to 2pi radians, the information bit having an associated inphase component I and an associated quadrature component Q, the inphase and quadrature components each having an associated polarity, the method comprising the steps of:
determining the inphase component I and the quadrature component Q of the information bit in the modulated complex signal;
determining an absolute ratio of the quadrature component Q to the inphase component I; and
determining from the polarity of the inphase and quadrature components the quadrant in which the modulation angle lies;
determining the arctangent of the absolute ratio x of the quadrature component Q to the inphase component I of the transmitted information bit in the modulated signal; and
determining the modulation angle from the polarity of the inphase and quadrature components and the arctangent of the absolute ratio of the quadrature component Q to the inphase component I of the transmitted information bit in the modulated signal.

11. The method of claim 10, further comprising comparing the absolute ratio of the quadrature component Q to the inphase component I with a number of predetermined ranges of values to determine which process to apply to obtain the value of the arctangent.

12. The method of claim 10, wherein the step of determining the arctangent of the absolute ratio x of the quadrature component Q to the inphase component I comprises determining the arctangent according to the equation:
atan(x)=x−x³/3+x⁵/5−x⁷17+x⁹/9−x¹¹/11+x¹³/13
if x lies in the range 0 to 7/16.

13. The method of claim 10, wherein the step of determining the arctangent of the absolute ratio x of the quadrature component Q to the inphase component I comprises determining the arctangent according to the equation:
atan(x)=atan(0.5)+atan(y)
where atan(y)=((x−0.5)/(1+0.5 x))−((x−0.5)/(1+0.5 x))³/3+((x−0.5)/(1+0.5 x))⁵/5−((x−0.5)/(1+0.5 x))⁷/7+((x−0.5)/(1+0.5 x))⁹/9−((x−0.5)/(1+0.5 x))¹¹/11+((x−0.5)/(1+0.5 x))¹³/13 . . .
if x lies in the range 7/16 to 11/16.

14. The method of claim 10, wherein the step of determining the arctangent of the absolute ratio x of the quadrature component Q to the inphase component I comprises determining the arctangent according to the equation:
atan(x)=atan(1)+atan(z)
where atan(z)=((x−1)/(1+x))−((x−1)/(1+x))³/3+((x−1)/(1+x))⁵/5−((x−1)/(1+x))⁷/7+((x−1)/(1+x))⁹/9−((x−1)/(1+x))¹¹/11+((x−1)/(1+x))¹³/13 . . .
if x lies in the range 11/16 to 19/16.

15. The method of claim 10, wherein the step of determining the arctangent of the absolute ratio x of the quadrature component Q to the inphase component I comprises determining the arctangent according to the equation:
atan(x)=atan(1.5)+atan(p)
where atan(p)=(x−1.5)/(1+1.5 x)−((x−1.5)/(1+1.5 x))³/3+((x−1.5)/(1+1.5 x))⁵/5−((x−1.5)/(1+1.5 x))⁷/7+((x−1.5)/(1+1.5 x))⁹/9−((x−1.5)/(1+1.5 x))¹¹/11+((x−1.5)/(1+1.5 x))¹³/13 . . .
if x lies in the range 19/16 to 39/16.

16. The method of claim 10, wherein the step of determining the arctangent of the absolute ratio x of the quadrature component Q to the inphase component I comprises determining the arctangent according to the equation:
atan(x)=atan(INF)+atan(−1/x)
where atan(−1/x)=(−1/x)−((−11×))³/3+((−1/x))⁵/5−((−1/x))⁷/7+((−1/x))⁹/9−((−1/x))¹¹/11+((−1/X))¹³/13.
if x lies in the range 39/16 to infinity, where atan(INF)=1.5708.

17. The method of claim 10, wherein the step of determining the modulation angle comprises determining the modulation angle according to the equation:
modulation angle=atan(x)
if the polarity of the inphase and quadrature components is positive.

18. The method of claim 10, wherein the step of determining the modulation angle comprises determining the modulation angle according to the equation:
modulation angle=pi-atan(x)
if the polarity of the inphase component I is negative and the polarity of the quadrature component Q is positive.

19. The method of claim 10, wherein the step of determining the modulation angle comprises determining the modulation angle according to the equation:
modulation angle=pi+atan(x)
if the polarity of the inphase component I and the quadrature component Q is negative.

20. The method of claim 10, wherein the step of determining the modulation angle comprises determining the modulation angle according to the equation:
modulation angle=2*pi-atan(x)
if the polarity of the inphase component I is positive and the polarity of the quadrature component Q is negative.

21. The method of claim 10, wherein the step of determining the arctangent of the absolute ratio x of the quadrature component Q to the inphase component I comprises determining the arctangent according to the equation:
atan(x)=x
if x lies in the range 0 to 7/16.

22. A method for determining modulation angles of a complex signal comprising repeating applying the method of claim 10 for each information bit in the modulated complex signal to be demodulated.

23. A method for determining modulation angles of a complex signal which has been modulated according to a phase shift keying (PSK) or a differential phase shift keying (DPSK) modulation scheme comprising the method of claim 10.
